(19) United States
(12) Patent Application Publication
(10) Pub. No.: US 2008/0073511 A1
(43) Pub. Date: Mar. 27, 2008

(54) Structured Copolymer Supports for Use in Mass Spectrometry

(75) Inventors: Ales Svatos, Jena (DE); Alexander Muck, Jena (DE)

Correspondence Address: CAESAR, RIVISE, BERNSTEIN,;COHEN & POKOTILOW, LTD., 11TH FLOOR, SEVEN PENN CENTER, 1635 MARKET STREET, PHILADELPHIA, PA, 19103-2212, US

(73) Assignee: MAX-PLANCK-GESELLSCHAFT ZUR FORDERUNG DER WISSENSCHAFTEN E.V., Munchen, DE (US)

(21) Appl. No.: 11/718,483

(22) PCT Filed: Nov. 4, 2005
(86) PCT No.: PCT/EP05/11834

§ 371 Date: Jun. 28, 2007

(30) Foreign Application Priority Data
Nov. 5, 2004 (DE) 10 2004 053 458.6

(51) Int. Cl. H01J 49/00

(52) U.S. Cl. 250/288

(57) ABSTRACT

The invention relates to novel structured copolymer supports for use in spectrometry, especially sample supports for use in mass spectrometry, having improved surface properties and to an especially advantageous novel process for the production of these structured copolymer supports.

The present invention relates to novel polymeric supports, especially for use in mass spectrometry, and to processes for their production.

In recent years mass spectrometric techniques as methods for the analysis of biological macromolecules such as proteins and nucleic acids have become increasingly significant. In particular, matrix-supported laser desorption/ionization mass spectrometry (MALDI-MS) and surface-supported laser desorption/ionization mass spectrometry (SELDI-MS) are principally efficient methods and are frequently used recently to determine the molecular masses of biomolecules such as proteins. Nevertheless, there are still problems when using them to analyze some proteins such as membrane proteins or protein samples contaminated with salt and the sensitivity of the assays is sometimes insufficient.

Various materials such as, e.g., metals, coated metals and polymeric plastics have already been used as support surfaces for the protein samples. Quite recently, polymeric plastic supports have been recommended by different authors on account of their economical production and good signal yield. For example, polyethylene membranes (Worrall et al., Anal. Chem. 1998, 70, 750-756) and supports based on poly(methylmethacrylate) (PMMA) and polycarbonate (PC) (Marko-Varga et al., Elektrophoresis, 2001, vol. 22, 3978-3983; Ekstrom et al., Elektrophoresis 2001, vol. 22, 3984-3992) have been described in the state of the art as suitable examples for such polymeric plastics.

However, these supports of the state of the art have the disadvantage that they are produced from commercial polymers and pre-cast plastic foils so that the surface properties of the polymeric support material were preset. Furthermore, in order to produce these supports relatively expensive and complex traditional processes were used that were borrowed from the polymer industry and the electronics industry.

### BRIEF SUMMARY OF THE INVENTION

A first object of the present invention in view of this state of the art was to increase the detection sensitivity of mass spectrometric assays for biological macromolecules, such as proteins and nucleic acids, in which such polymeric sample supports are used in a simple and economical manner.

A related second object was to provide a simpler and more economical process for the production of polymeric supports, in particular for use in mass spectrometry.

To this end, extensive investigations of the inventors showed that the detection sensitivity of a mass spectrometric assay for the analysis of biomolecules, such as proteins, peptides and nucleic acids, in which these modified supports are used could be significantly increased by a purposeful selection and/or modification of the polymeric support material in order to produce or enhance certain surface properties, e.g., hydrophobicity, polarity, etc. With the sample supports of the state of the art such a modification can take place only by a subsequent derivatization of the surface by a chemical and/or physical treatment. Such a treatment is time-consuming and often results in non-optimal yields of desired product.

The inventors now observed that structured polymeric supports can be produced with desired surface properties in a simple, rapid and economical manner in that a polymerization solution comprising the required monomer components for obtaining a polymer or copolymer with the desired properties is directly brought to polymerization in a mould that corresponds to the intended three-dimensional structure of the support.

Due to the simplicity and rapidity of this process the sample supports can also be produced in small laboratories for, e.g., mass spectrometric analyses tailored for the specific requirements of the particular samples in order to optimize the detection sensitivity of mass spectrometric assays in this manner.

The above-cited objects are therefore achieved in accordance with the invention by providing structured copolymeric supports in accordance with claims 1-14, in particular by the method of claim 15, and by their use in spectrometry, especially mass spectrometry in accordance with claims 16-21.

### DETAILED DESCRIPTION OF PREFERRED EMBODIMENTS OF THE INVENTION

The present invention discloses novel structured copolymeric supports for use in spectrometry and spectroscopy, especially sample supports for use in mass spectrometry, with improved surface properties and an especially advantageous novel process for producing these structured polymeric supports in which a polymerization solution comprising the monomers or macromonomers to be polymerized is caused to polymerize in a mould comprising a negative of the desired structure, and the polymerizates formed are detached from the mould.

The concept “polymerization” as used herein is intended to comprise all types of conversion of relatively low-molecular compounds, “monomers”, into high-molecular compounds, “polymers”, and also comprise, in addition to polymerization in the narrower sense, that proceeds continuously, polycondensation and polyaddition as step reactions. The relatively low-molecular compounds can also be oligomers or short-chain polymers (molecular mass in a range of approximately 100 to 100000 daltons), so-called “macromonomers”, that are further polymerized like simple monomers. In this manner, e.g., graft copolymers can be produced in which the main polymer skeleton is provided with side chains of a certain comonomer.

Accordingly, the produced polymeric and/or copolymeric supports can be selected from a broad spectrum of known plastics, e.g., polyesters, polycarbonates, polyolefins, poly(meth)acrylates, in particular polymethylmethacrylates, and their copolymeric derivatives, with the proviso that the basic suitability for the desired application purpose, e.g., as sample support for use in mass spectrometry must be given. The particular required basic properties, e.g., hardness, resistance to laser action, certain solvents, etc., and the corresponding basically suitable plastics are readily apparent to those skilled in the art.

According to the invention the surface properties of the polymeric or copolymeric support are determined by the suitable selection of the monomeric components in the desired manner. For example, the surface charge can be influenced and ionic interactions can be promoted by using a monomer with strongly polar or charged substituents. In order to produce or increase a negative surface charge and attract positively charged analytes, e.g., monomers with sulfo-, hydroxyl- or carboxy groups can be used. A few non-limiting examples for this are methacrylic acid, acrylic acid, carboxyethyl-acrylate, hydroxymethylmethacrylate, hydroxyethylmeth-acrylate, hydroxypropylmethacrylate, acryloyloxyhydroxy-propylmethacrylate, 2-(2-ethoxyethoxy)ethylmethacrylate, monohydroxystyrene, methylpropene sulfonic acid, sulfoethyl-methacrylate, sulfopropylacrylate, 2-(methyl)-12-crown-4-methacrylate, 2-(methyl)-15-crown-5-methacrylate, 2-(methyl)-18-crown-6-methacrylate, etc. In order to produce or increase a positive surface charge and attract negatively charged analytes, e.g., monomers with amino groups can be used. A few non-limiting examples for this are aminoethylmethacrylate, aminopropylmethacrylate, N-(3-aminopropyl)methacrylamide, N-(3-vinylbenzyl)-N,N-dimethyl-octadecyl ammonium chloride, etc. A base monomer with a moderate hydrophobicity such as, e.g., methylmethacrylate, can be converted by copolymerization with a more hydrophobic monomer into a copolymer with a desired degree of hydrophobicity in order to reinforce therewith, e.g., the binding of hydrophobic samples to the support surface. A few suitable, non-limiting examples for more hydrophobic comonomers are C₂₋₁₈-alkylmethacrylate, hexafluorobutylmethacrylate and other fluorinated alkyl-methacrylates. The interaction of a non-aromatic base homopolymer with analytes containing an aromatic or heteroaromatic group can be enhanced by using a partially aromatic comonomer. Such analytes are, e.g., proteins and peptides that contain phenylalanine, tryptophan or tyrosine, aromatic fatty acids and triglycerides. A few suitable, non-limiting examples for aromatic comonomers are benzylacrylate, benzylmethacrylate, divinylbenzene, styrene and their derivatives, furfurylmethacrylate, anthracenylmethacrylate, N-acryloxysuccinimide, 4-chlorophenylacrylate, 4-methacryl-oxy-2-hydroxybenzophenone, 2-(2′-methacryloxy-5′-methyl-phenyl)benzotriazole, etc.

A continuous polymerization takes place in a preferred embodiment of the invention and the polymerization solution used comprises at least one monomer or a macromonomer derived therefrom that comprises a vinyl group. The polymerization solution typically comprises at least two different such monomers or macromonomers. Preferably, this monomer or these monomers are selected from the group of (meth)acrylic acid, (meth)acrylates, substituted (meth)acrylates, (meth)acryl-amides, substituted (meth) acrylamides, (meth)acrylonitrile, substituted (meth)acrylonitrile, styrene and substituted styrenes, divinyl benzene and substituted divenylbenzene, butadiene, ethylene glycoldimethacrylate, di(ethylene glycol) dimethacrylate, ethylene glycol diacrylate, di(ethylene-glycol) diacrylate, 3-(acryloyloxy)-2-hydroxypropylmeth-acrylate and N,N′-methylene bismethacrylamide.

More particularly, the optionally substituted (meth)acrylates are alkyl(meth)acrylates, substituted alkyl(meth)acrylates, aryl(meth)acrylates or substituted aryl(meth)acrylates. The substituted alkyl(meth)acrylates or substituted aryl-(meth)acrylates can have, e.g., sulfo-, hydroxy-, carboxy- or amino functionalities. A few non-limiting examples for this are methacrylic acid, acrylic acid, carboxyethylacrylate, hydroxymethylmethacrylate, hydroxyethylmethacrylate, hydroxy-propylmethacrylate, acryloyloxyhydroxy propylmethacrylate, 2-(2-ethoxyethoxy)ethylmethacrylate, sulfoethylmethacrylate, sulfopropylacrylate, 2-(methyl)-12-crown-4-methacrylate, 2-(methyl)-15-crown-5-methacrylate, 2-(methyl)-18-crown-6-meth-acrylate, aminoethylmethacrylate, aminopropylacrylate, etc.

In an especially preferred embodiment the polymerization mixture comprises as main monomer ethyl- or methylmethacrylate and one or more copolymers that modifies/modify the surface properties of the polyethyl- or polymethylmethacrylate homopolymer in the desired manner.

One possibility for increasing the hydrophobicity is, e.g., the incorporation of an alkylmethacrylate comonomer with an alkyl chain longer than methyl or ethyl, preferably in a range of C₃-C₁₈, e.g., propyl, butyl, pentyl, hexyl, heptyl, octyl, nonyl, decyl, undecyl, duodecyl to octadecyl, or of fluorinated alkylmethacrylates as cited above.

On the other hand the surface charge can be influenced and the ionic interaction with certain samples enhanced by using a comonomer with strongly polar or charged substituents.

In order to produce or increase a negative surface charge and attract positively charged analytes, e.g., comonomers with sulfo-, hydroxy- or carboxy groups, e.g., aryl- or alkyl-methacrylates, preferably alkylmethacrylates, with sulfo-, hydroxy- or carboxy groups can be used. A few non-limiting examples for this are methacrylic acid, acrylic acid, carboxyethylacrylate, hydroxymethylmethacrylate, hydroxy-ethylmethacrylate, hydroxypropylmethacrylate, acryloyloxy-hydroxypropylmethacrylate, 2-(2-ethoxyethoxy)ethylmethacrylate, sulfoethylmethacrylate, sulfopropylacrylate, 2-(methyl)-12-crown-4-methacrylate, 2-(methyl)-15-crown-15-meth-acrylate, 2-(methyl)-18-crown-6-methacrylate.

In order to produce or increase a positive surface charge and attract negatively charged analytes, comonomers with amino groups can be used, e.g., aryl- or alkylmethacrylates with amino groups, preferably aminoalkylmethacrylates, e.g., aminoethylmethacrylate, aminopropylmethacrylate. In order to increase the n-n interactions with analytes containing an aromatic or heteroaromatic group, comonomers with aryl groups, preferably arylmethacrylates can be used. A few non-limiting examples for this are benzylacrylate, benzylmethacrylate, anthracenylmethylacrylate, furfurylmethacrylate, 4-chlorophenylacrylate.

The amounts of the various comonomers can vary as appropriate from 0.001 to 99.999%, more particularly from 0.01 to 99.99%, typically from 0.1 to 99.9%, preferably from 1 to 99%, especially preferably 10 to 90%.

In another aspect of the present invention the polymerization solution contains substantially only one monomer, so that a homopolymer is formed. A preferred monomer in this embodiment is a C₄₋₆-alkylmethacrylate, preferably butylmethacrylate or a substituted, e.g., hydrophilic substituted derivative thereof.

The polymerization reaction used may be an ionic or radical polymerization. Accordingly, the polymerization solution may also contain a catalyst for the ionic or radical polymerization in addition to the monomers as well as optional solvents and/or other auxiliary substances. Suitable catalysts for the particular reaction type and the particular monomer types are known in the state of the art.

The polymerization is preferably a radical polymerization that can be initiated, e.g., by x-ray radiation or gamma radiation, UV light or by thermal treatment, and the polymerization solution contains a radical polymerization catalyst. In particular for copolymers based on methacrylate, benzoinmethylether (α-methoxy-α-phenylacetophenone) is a preferred catalyst for a radical polymerization under UV light. However, other known catalysts are also suitable.

In a strongly preferred embodiment the radical polymerization is initiated by UV light. In particular for the polymerization of monomers based on methacrylate, UV light with a wavelength in a range of 350-400 nm, in particular approximately 365 nm, is preferably used.

The polymerization and the forming of the structured supports can basically take place under different conditions according to any known and suitable process, e.g., injection moulding, compression moulding, forming under atmospheric pressure, etc.

However, it is especially advantageous that the production of the structured supports takes place under ambient conditions, that is, atmospheric pressure and ambient temperature. In this manner no complicated and expensive apparatuses are necessary and the inventors observed that the polymerization reaction can nevertheless take place rapidly and completely under these conditions. For polymers and copolymers based on methacrylate the UV-induced polymerization reaction usually is completed after a few hours already, preferably approximately 1 to 2 hours.

The forming of the polymeric supports preferably takes place simultaneously with the polymerization in that a polymerization solution comprising the monomers or macromonomers to be polymerized is caused to polymerize directly in a mould that comprises a negative of the desired structure. However, it is also possible to first produce an unstructured polymerizate and to give it the desired structure in a second step according to any suitable process, e.g., injection moulding or stamping.

The mould part that represents the negative of the desired support structure may basically consist of very different material, e.g., glass, metal, plastic, have a very different size and form as required and be produced in any known manner. However, it is necessary that the desired microstructures, that typically have a depth in a range of 1 to 1000 μm, more frequently 10 to 100 μm, e.g., approximately 50 μm, in supports for use in mass spectrometry can be transferred with great accuracy onto the polymerization products and that the resulting polymerizates or copolymerizates can be readily separated from the mould. Furthermore, the mould part should be able to be produced as simply and economically as possible.

In a strongly preferred embodiment this mould part is a silicon wafer and the structure of the silicon wafer is especially preferably produced by photolithography, followed by a chemical and/or physical treatment of the wafer, e.g., by wet chemical etching. Such a process for producing silicon wafers as negative for structured microchips based on PMMA has already been described by the inventors of the present invention (Anal. Chem. 2004, 76, 2290-2297) and adapted and further developed for the production of structured copolymeric specimen supports for use in mass spectrometry in accordance with the invention. The production of a corresponding silicon wafer in accordance with this simple and efficient process is described in detail in example 1. The formation of a suitable mould using this silicon wafer takes only a few minutes and is also described in example 2 as well as the actual polymerization and subsequent further treatment of the polymerizates formed.

Compared to traditional sample supports the polymeric supports produced in accordance with the invention have improved surface properties that can be adjusted as a function of the specific analytes to be examined. The analytes are preferably biomolecules, that is, compounds naturally occurring in living organisms, and metabolites, that is, metabolic products of various types. The analytes are typically proteins, peptides, nucleic acids, lipids and other small and large biomolecules, but may also comprise small and large molecules of non-biological origin. A special advantage of these supports is that the sample material may contain contaminants such as salts, detergents, buffers, etc that can be readily separated from the more strongly binding analytes on account of the poorer binding to the support surface. The analyte molecule freed of contaminants then produces a comparatively stronger signal with lesser background noise directly in the particular detection system, preferably MALDI- or SELDI mass spectrometry and/or emission spectroscopy or absorption spectroscopy (such as, e.g., fluorescence spectroscopy), and can be detected in lesser concentrations. That is, the detection sensitivity of such assays can be significantly increased.

The sample supports in accordance with the invention therefore enable without further modification steps the sample cleaning or specific adsorption of the samples and their direct measuring on the same platform. In contrast to known systems of the state of the art, no pump systems and rather long separation times are necessary, the application of an electrical voltage for desalination/sample adsorption is superfluous and also no porous structures have to be produced that require an elution of the sample from the system (such as, e.g., in monolithic solid-phase extraction systems) and limit the spectrum of the possibilities for producing and using the supports.

These advantages of the supports in accordance with the invention are not limited only to mass spectrometric applications. The copolymeric supports with specific surface properties can also be advantageously used for all other applications in which the preferred binding of specific types of molecules to a support is used. Examples for this are in particular other spectrometric techniques, e.g., emission- and absorption spectroscopy, and combinations of other spectrometry techniques with mass spectrometry, e.g., a combination of MALDI mass spectrometry and fluorescence spectroscopy.

In a specific embodiment of the present invention copolymeric surfaces are used with functionalities to which linker or spacer molecules can be coupled. Molecules of interest can be bound to the latter in a known manner. An example of the application of this principle is demonstrated by the enzymatic assay of example 7 in which an enzyme (alkaline phosphatase) was bound via a spacer molecule to the surface. In this manner the free mobility of the enzyme and therewith its activity relative to a selected substrate was insured so that a direct and sensitive monitoring of the enzymatic activity became possible by means of MALDI mass spectrometry and UV/VIS spectroscopy.

### BRIEF DESCRIPTION OF SEVERAL VIEWS OF THE DRAWINGS

FIG. 1 is a general scheme illustrating the production of copolymeric supports in accordance with the invention and their use in a spectrometric method:

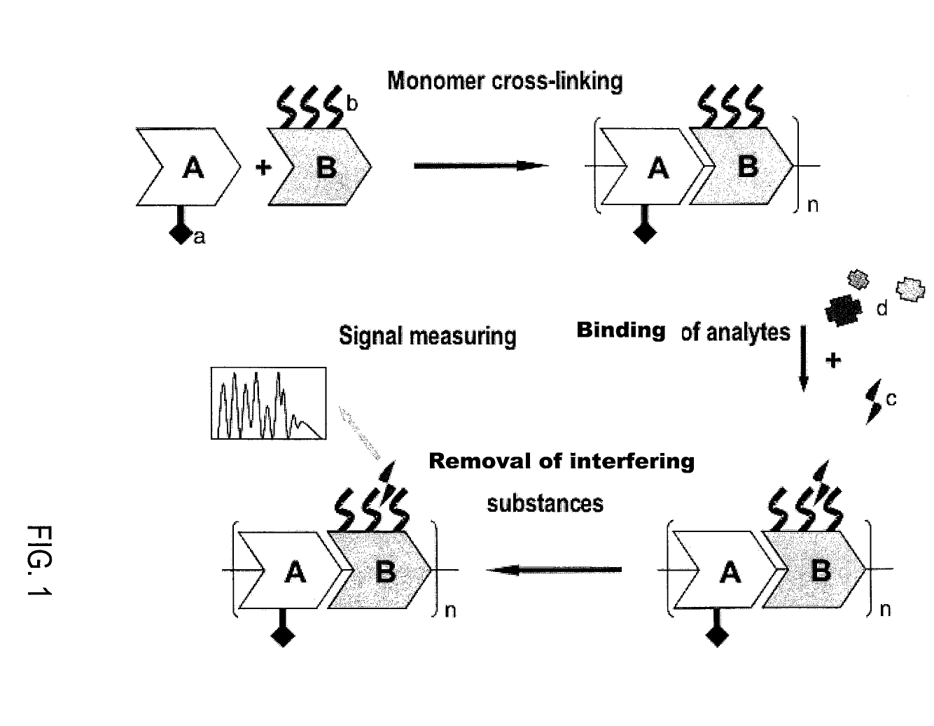

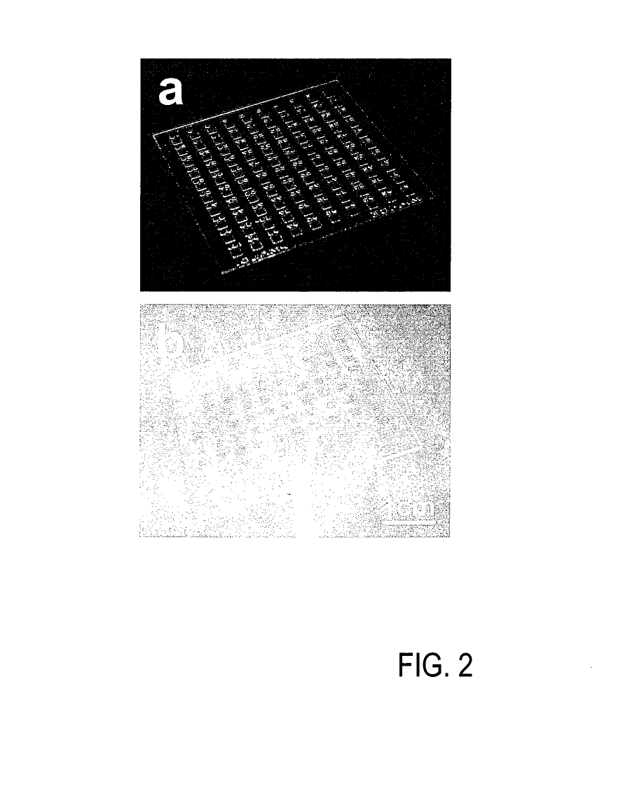

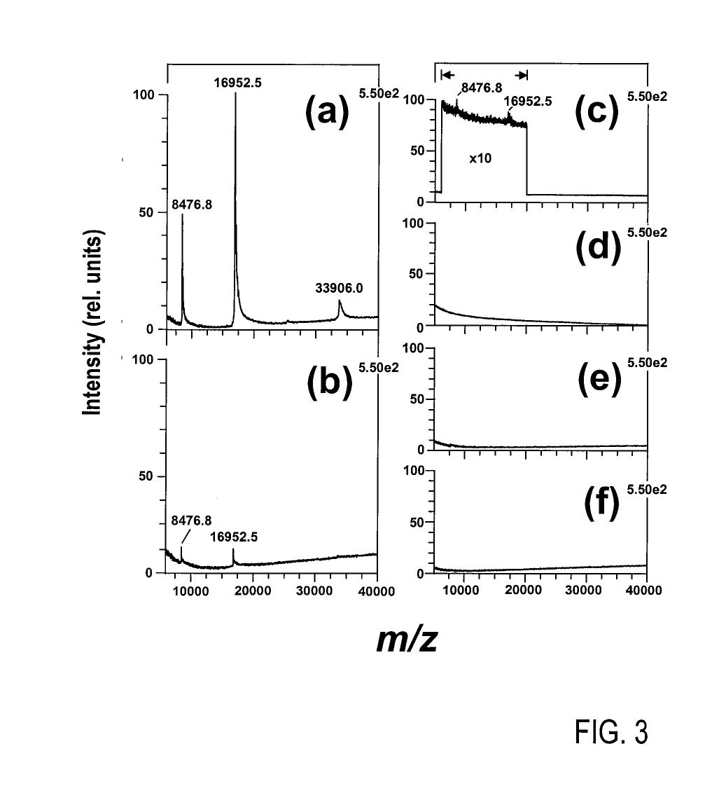

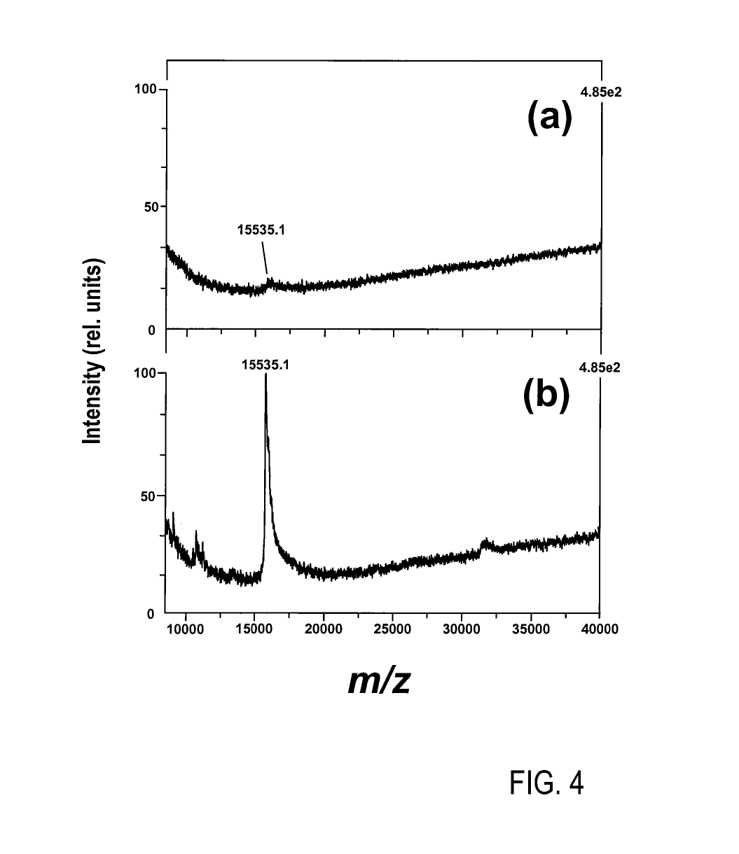

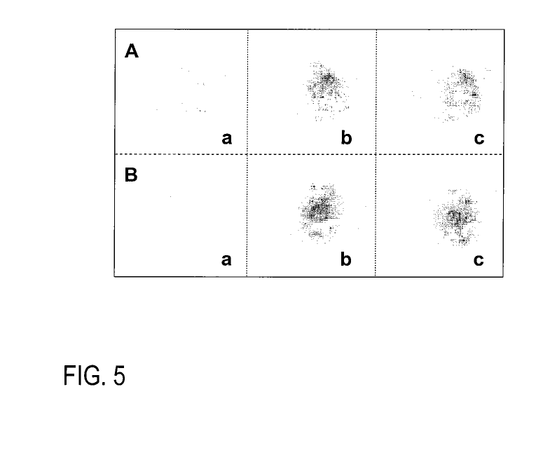

Selected monomers (here A and B) are polymerized under suitable conditions (e.g., catalysts, UV light) to a chain with n units of basically any sequence (adjustable if desired) and provide different sites (a) and (b) for interaction with the samples to be examined on the surface of the resulting copolymerizates (and throughout in the entire material). A complex sample containing the analyte molecule (c) and interfering molecules (d) (e.g., salts, detergents, buffers, etc.) is placed on the surface of the polymeric support chip. Due to the specifically adjusted surface properties of the support, the analyte molecule binds with preference to the surface and the contaminating molecules with a lower affinity to the surface are readily removed. The analyte molecule freed of contaminants then produces a comparatively stronger signal with lesser background noise in the particular detection system.

FIG. 2 shows photographs of a silicon wafer negative (a) produced in accordance with example 1 and of the polymeric support chip (b) produced therewith in accordance with example 2.

FIG. 3 shows MALDI-TOF spectra of horse heart myoglobin in 4 M urea and 0.1% trifluoroacetic acid on a poly(butylmethacrylate-co-methylmethacrylate) sample support after in situ desalination on the support (a) and without desalination (b) and the corresponding reference spectra after and before desalination on a PMMA sample support (c,d) and a steel sample support (e,f).

FIG. 4 shows MALDI-TOF spectra of a PAGE gel electrophoresis sample of an insect-Δ-11-desaturase membrane protein fragment (MG 15534 Da) in 100 mM phosphate, 10 mM TRIS buffer, 0.5 M NaCl salt and 10 mM EDTA elution buffer after in situ desalination on the poly(butylmethacrylate-co-methyl-methacrylate sample support (4b) and reference spectra without desalination (4a).

FIG. 5 shows microphotographs of the enzymatic hydrolysis of p-nitrophenolphosphate (transparent) to free p-nitrophenol (dark) in two parallel batches (A, B). Panels Aa and Ba correspond to wells in which phosphatase was coupled directly to the support surface, whereas panels Ab, Ac respectively Bb and Bc correspond to wells in which the phosphatase was coupled to the copolymeric chip via a linker.

The process in accordance with the invention was used to produce structured sample supports for use in mass spectrometry whose structure and dimensions corresponded to those of traditional sample supports of steel in order to enable their use in conventional mass spectrometry apparatuses. Specifically, chips having dimensions of 50×50×2 mm with 100 square-shaped positions with a side length of 2 mm in 10×10 rows were produced. The distance between the individual positions was 2.26 mm.

### Example 1

The production of the chips took place by forming under atmospheric pressure. At first, a silicon wafer of the p-type with <100> orientation and 100 mm diameter was produced as negative by a combination of photolithography and wet chemical etching. In contrast to earlier reports (Anal. Chem. 2004, 76, 2290-2297) an airbrush process was used to apply the photoresist coating A reproducible coating of silicon wafers was achieved with a self-made glass airbrush consisting of an inner spray device (inlet tube for the resist solution of 100 mm×3.8 mm ID with an L-shaped spray nozzle with a diameter of 1 mm) in the middle of an outer glass tube (20 mm diameter) with a vertical air inlet (20 mm×3.8 mm inside diameter) and a ground connection piece to a 100 ml container of brown glass. The exit opening of the spray nozzle was centered 1 mm from the exit opening with 3.8 mm diameter in the outer glass tube. In order to ensure a uniform separation of microscopic droplets of the photoresist the negative resist SU-8 5 (Microchem, Inc., Newton, Mass., USA) was diluted with acetone (50 ml, 3/2 vol./vol.). The resist mixtures were homogenized by a ten-minute sonication in the dark and manually sprayed at a vertical distance of 20 cm for 10 seconds at a constant air pressure of 2 bar onto the silicon wafer. Under these simple conditions resist layers of 10-15 μm thick could be deposited.

The photolithography masks were produced with the aid of a commercial image-generating software as negatives of the replicated structures and printed out on standard PMMA transparent foils for laser printing with an optimized black-white resolution of 1200 dpi. After the coating the wafers were dried for 30 minutes at 90° C. and subsequently covered with the photomask for the UV illumination. The alignment took place manually in the “flat” orientation of the wafer. The wafer was then covered with a quartz glass plate (150×150×2 mm) and exposed for 30 minutes to UV light (365 nm, 8 W, 550 PW/cm² at a distance of 15 cm, Carl-Roth). A 40-minute heat gradient treatment from 65 to 90° C. (5° C./min.) followed and the wafer was subsequently developed for 90 s in a glass Petri dish with developer (XP SU-8, Microchem, Corp.). The non-exposed photoresist was removed by immersion in 2-propanol for 30 respectively 10 s. Thus, only the desired structure was photopolymerized on the wafer. A “baking” subsequently took place by heating the wafer for 60 minutes at 150° C.

The wet chemical etching took place in two steps. At first, the exposed silicon oxide layer around the structure covered with photoresist was etched isotropically in a buffered hydrofluoric acid solution during which an SiO₂ mask was produced that was identical to the original photolithography mask for the second step of the etching of the silicon substrate. The wafer was subsequently thoroughly rinsed with distilled water and etched in a 40% KOH solution (containing 5% 2-propanol) and 600 anisotropically under constant monitoring until the desired structures were present in the desired depth and height (approximately 40 min.).

### Example 2

An open mould for the polymerization was formed in that a quadratic aluminum plate was placed as spacer between a wafer produced as in example 1 as negative and a glass plate and was fastened with a Teflon band and laboratory clamps. The spacer had a 1 mm wide inlet opening for the monomer solutions. The desired monomer solutions (here methylmethacrylate and butylmethacrylate; ratio 4:6, vol./vol.) were freed of hydroquinone inhibitor by means of column chromatography with activated aluminum oxide (grade CG20), degassed (e.g., by sonication) and brought into the mould. The polymerization solution contained 0.3% (wt./vol.) benzoinmethylether as catalyst. The polymerization took place by UV irradiation (365 nm, 8 W, Carl Roth) for approximately 1 hour in a ventilated closed hood. The polymerizates were freed from the mould by sonication (10 min. in water at 40° C.) and cleaned in 2-propanol. In order to eliminate inner tensions the polymerizates were subjected to a 10-minute thermal treatment at approximately 70° C. in a convection oven. After slowly cooling off to ambient temperature the supports were stored overnight in a vacuum in order to remove any remaining traces of monomers. An inspection with an optical microscope showed a high replication fidelity of the formed structures without distortions or shrinking.

### Example 3

A sample support produced as in example 2 and consisting of poly(butylmethacrylate-co-methylmethacrylate) (ratio MMA:BMA 4:6, vol./vol.), a sample support produced in the same manner and consisting of polymethylmethacrylate homopolymer and a traditional sample support of steel were used for the mass spectrometric analysis of horse heart myoglobin (90%, Sigma-Aldrich). The polymer supports were used without prior surface treatment whereas the sample supports of stainless steel were washed with concentrated nitric acid under brief sonication in order to remove any contaminants, cleaned off with deionized water and dried in air. 1.2 μl myoglobin solution (in 0.1% trifluoroacetic acid, TFA) were mixed with 1.2 μl of a solution of sinapic acid matrix (9 mg/ml) in 60/40 vol./vol. 0.1% TFA/acetonitrile) with the aid of 10 μl Eppendorf tips and aliquots of 1.2 μl applied onto the application positions. The drops were allowed to dry in air at ambient temperature and the support plates were introduced into the MALDI source. The samples, that contained buffer salts, were produced in the same manner and dried at ambient temperature. The desalination procedure was carried out by a simple application of 1.5 μl 0.1% TFA for 1 minute followed by droplet removal with the aid of a new 10 μl pipette tip. The desalinated application positions were allowed to dry and introduced into the MALDI source.

The spectra were recorded using a TofSpec 2E-MALDI TOF instrument (Micromass, Manchester, UK) that was operated in a linear mode as well as a reflectron mode with delayed extraction. The desorption/ionization took place with a CO₂-UV laser (337 nm, 4-ns-pulses with 180 mJ). The positive ions were exposed to an acceleration potential of 20 kV and detected with a dual microchannel plate (MCP) detector. Matrix ions were suppressed with a cut-off of low masses (m/z 600). 5 laser impulses per measurement were emitted and the obtained spectra were average values of at least 20 successive measurements. Smoothed and baseline-corrected data was calibrated if necessary using calculated mono-isotropic masses of (M+H) peaks. The data was recorded and analyzed with the aid of the MassLynx 3.2 software on a PC workstation.

FIG. 3a shows the spectrum of a myoglobin sample of 10 μmol in 4 M urea that had been mixed as described above with matrix solution and applied. After drying and desalination by a one-minute incubation with 0.1% TFA solution the salts primarily dissolved in the aqueous phase were removed and the more hydrophobic proteins retained on the hydrophobic sample support. The small amount of matrix that also remained was sufficient for ionizing the protein. A strong molecular ion peak was observed adjacent to the double-protonated molecular ion and single-protonated dimer peaks.

An analogous sample pre-treatment on a PMMA surface resulted in a significantly lesser degree of protein adsorption, which indicates a lower binding tendency for the examined protein type, and yielded only relatively weak signals from myoglobin (FIG. 3c), whereas no signal at all was observed with the steel reference sample support (FIG. 3e).

The measuring of a non-desalinated sample on the new butyl-modified sample support also resulted in still detectable signals (3b), whereas no signals were observed on the PMMA surface (3d) or the steel support (3f) without desalination.

### Example 4

A MALDI-TOF mass spectrometry under the conditions described in example 3 was carried out with 20 μmol of the Δ-11-desaturase membrane protein fragment 90-180 (MG 15534 Da) in a complex buffer containing 100 mM sodium dihydrogen phosphate and 10 mm TRIS buffer, 0.5 M NaCl and 10 mM EDTA. The samples were desalinated in a batch as described in example 3 and the efficient adsorption of the hydrophobic membrane protein on the sample support in accordance with the invention resulted in an intensive molecular ion peak (FIG. 4b) whereas the non-desalinated sample of a reference batch yielded only a minimal signal (FIG. 4a).

### Example 5

Sample supports of poly(methylmethacrylate-co-2-sulfoethyl-methacrylate) (material A) respectively poly(methyl-methacrylate-co-methacrylate (material B) were produced as representatives of copolymers with negatively charged functionalities in a mould as described in example 2.

At first, an inhibitor-free solution of the methylmethacrylate monomer (Polysciences Inc., Warrington, Pa.) was mixed with 2-sulfoethylmethacrylate (Polysciences Inc.) in a ratio of 97:3 (vol./vol.) or with methacrylic acid (Polysciences Inc.) in a ratio of 94:6 (vol./vol.). Then, 0.3% (wt./vol.) benzoinmethylether (Polysciences Inc.) was added as UV catalyst and the solutions exposed for 1 h to UV light with 365 nm wavelength in order to obtain a viscous pre-polymer solution. Such a prepolymer solution can be stored refrigerated if desired for rather long time periods. Before the forming the viscous solutions were held in a vacuum for 1 minute in order to prevent gas from being released during the polymerization process. The solutions were then introduced in identical moulds with the desired negative structure and polymerized for approximately 2 h under UV light with a wavelength of 365 nm. The freeing from the mould took place as described in example 2. After the rinsing of the surfaces of the produced sample supports with 5 mM ammonium hydroxide solution the surfaces were negatively charged due to the dissociation of protons of the carboxy or sulfo functionalities, respectively.

1 μl of a phosphorylase B digest with trypsin (MassPrep, Waters Inc.), corresponding to 100 fmol of each peptide, in 50 mM ammonium hydrogencarbonate buffer, pH 8.5, was applied onto the particular support surfaces in order to test the absorption efficiency. After 1 minute of incubation the solutions were removed with the aid of a 10 μm pipette tip and 1 ml α-cyano-4-hydroxy cinnamic acid matrix (5 mg/ml in ethanol/acetonitrile/0.2% trifluoroacetic acid 6/3, 5/0.5 vol./vol.) applied. After the drying the supports were introduced into the MALDI ion source and mass spectra were recorded in a positive ion reflectron mode.

A series of intensive peaks of single-protonated peptides in the m/z range between 800-2000 da was observed. The most intensive peaks were identified as [M+H]⁺ peaks from T92 (SwissProt database) at 1278.67 daltons, followed by T86 at 1053.65 da and T70 at 869.29 da. This demonstrated the adsorption of positively charged peptides onto the copolymeric target surfaces. In order to evaluate the efficiency of the buffer salt removal and the detection sensitivity for materials A and B, the average signal-noise ratio (S/R) was calculated for signals that had been averaged over 1 minute of recording. Copolymer A modified with sulfoethylmethacrylate yielded an S/R ratio of 45 for the peak of 1278.67 da in comparison to an S/R ratio of 2 for a sample without desalination. A higher S/R value of 62 was obtained for the identical ion for copolymer B (methacrylate-modified material) in comparison to an S/R value of 2.5 for the non-desalinated sample. The slightly lower value for material A may be due to a partial absorption of water molecules on account of the elevated hydrophilicity of the material.

### Example 6

In order to test the sample pretreatment and signal improvement in the MALDI-TOF analysis of complex nucleic acid samples a positively charged copolymer support was produced using a mixture of methylmethacrylate and aminoethylmethacrylate in a ratio of 98:2 (vol./vol.).

The 2-aminoethylmethacrylate was first extracted according to the following process: 2-aminoethylmethacrylate hydrochloride (Polysciences Inc., Warrington, Pa., USA) was dissolved in water (0.7 g in 10 ml deionized water) and the acid was neutralized by the addition of sodium carbonate (Sigma) (0.7 g in 50 ml water) and 20 minutes of agitation. The free monomer was extracted with ethyl acetate (Sigma) (3×40 ml) and the remaining carbonate removed by shaking out with a saturated solution of NaCl (Sigma) (10 ml). The organic phase was separated and concentrated by evaporation in a vacuum. The yield from the extraction was approximately 20%. The viscous aminoethyl monomer solution was mixed with inhibitor-free methylmethacrylate solution and the mixture was converted into a prepolymer solution under UV light in analogy with example 5 and then polymerized under UV light. The copolymerizates were separated from the mould as already described and stored overnight under a vacuum.

2 μl of a DNA ladder (containing 10, 20 and 30 bp, corresponding to approximately 3500, 7000 and 14,000 da, Promega) in a concentration of 60 μmol/μl in 10 mM tris-HCl buffer, pH 4.9, 50 mM KCl, 5 mM MgCl₂ and 0.1 mM EDTA, were applied onto the sample support in order to test the signal improvement. A standard steel sample support (Micromass, UK) was used for comparison. The solutions were dried in air and rinsed for 1 minute with 2 μl deionized water, during which a 10 μl pipette tip was used. Then, 4 μl 3-hydroxy picolinic acid matrix (60 mg/ml) dissolved in a mixture of acetonitrile/water with a relatively low acetonitrile component (3/7) was applied onto the target areas. After drying, the sample supports were introduced into the MALDI ion source and mass spectra recorded in the negative ion mode.

Negative-mode spectra of desalinated DNA's on the amine-containing copolymeric support arrangements were characterized by intensive peaks of the two smaller oligomers of 10 and 20 bp and a weaker peak of the 30 bp DNA. In comparison to the above, the signals that had been recorded for samples without the rinsing step and for samples on the steel sample support were not resolved against the background. This can be attributed to a preferred retention of negatively charged DNA phosphate groups by the protonated amine functionalities during the removal of salt and the elimination of remaining K⁺ and Na⁺ ions (that result in a peak widening in the traditional MALDI-MS with a steel sample support) during the ionization by binding to some deprotonated carboxyl groups.

The above examples document the considerable advantages that can be achieved by using copolymeric supports in accordance with the invention as sample supports for biomolecules such as, e.g., proteins and nucleic acids, especially in mass spectrometric assays.

### Example 7

In order to test the suitability of copolymeric sample support chips as platforms for conducting enzymatic reactions and for their rapid detection a t-butylcarboxy-aminoethylmethacrylate/methylmethacrylate copolymer chip (polymerized in a vol./vol. ratio of 1:9 from monomers) was produced. Thus, sections of the polymer chain carried alkylated amino functionalities that could be rapidly activated into free amino groups to bind an enzyme via a spacer molecule, which ensured the free mobility of the enzyme and therewith its activity with a selected substrate in order to cause a chemical conversion of the substrate, which enabled a direct monitoring of the enzymatic activities by MALDI mass spectrometry and UV/VIS spectroscopy.

The surface of a t-butylcarboxyaminoethylmethacrylate/methylmethacrylate copolymer chip was activated with 2 μl of a mixture of HCl. conc./MeOH (1:1 vol./vol.). The surface of the chip was rinsed with copious water and held 5 minutes in an ultrasonic bath in bidist. water. 2 μl 0.1 M NaHCO₃ buffer, pH 9, were introduced into the 2×2 mm sample zone in order to neutralize any acidic residues on the surface. After repeated rinsing and a 5 minute treatment in an ultrasonic bath the chip was dried in a stream of nitrogen and 2 μl N-hydroxysulfosuccinimide-(polyethylene glycol) biotin (NHS-PEO₄ biotin cross-linking probe from Pierce Inc., Rockford, USA) in 0.1 M phosphate buffer, pH 7.4 were introduced into the sample well. The sample well was incubated for 1 h in a humid-air laboratory incubator at 15° C. and with gentle mechanical movement at 300 rpm. The surface of the well was then rinsed with bidist. water and 2 μl of a blocking solution (5 mg/ml bovine serum albumin in 0.1 M phosphate/borate buffer, pH 7.4) were introduced into the activated well in order to avoid any non-specific interactions of proteins with the surface. The blocking solution was incubated in the well for 1 h at 15° C. and with gentle mechanical movement at 300 rpm in the humid-air incubation chamber. The well surface was rinsed with copious water, dried in a stream of nitrogen and over-layed with 2 μl of 10 E/ml alkaline phosphatase cross-linked with streptavidin (Sigma). The enzyme was incubated 1 h at 15° C. and with gentle mechanical movement at 300 rpm in a humid-air laboratory incubator. The chip surface was rinsed with water. Finally, 2 μl p-nitrophenolphosphate (0.25 M) in 0.1 M TRIS buffer, pH 7.4 were added to the sample well.

A rapid enzyme-catalyzed hydrolysis was observed with a UV-VIS spectral photometer chamber adjusted to 570 nm. An extinction change of 0.001 to a maximal value of 0.09 was observed within 2.6 min. FIG. 5 shows microphotographs of the enzymatic hydrolysis of p-nitrophenolphosphate (transparent) to free p-nitrophenol (dark) in two parallel tests (A, B in FIG. 5). Reference wells with enzyme that had been directly adsorbed onto the copolymer surface showed a lesser color change after the addition of substrate and incubation, whereas on the other hand wells that contained alkaline phosphatase linked via the linker to the polymeric chip showed a high hydrolysis rate (Ab, Ac respectively Bb, Bc in FIG. 5).

The activity of the enzyme was subsequently checked in the source of the MALDI-TOF spectrometer. The chip surface was dried in air and the wells (containing alkaline phosphatase and its substrate p-nitrophenolphosphate) were overplayed with 0.6 μl hydroxypicolinic acid matrix (60 mg/ml in 7/3 water/acetonitrile). Once the plastic chip had been introduced into the MALDI source and vacuum had been established, deprotonated single-charge peaks of p-nitro-phenolphosphate were measured in the negative reflectron mode. The activity of the enzymatic reaction was measured by integration of the molecular peak areas of p-nitrophenolphosphate. In comparison to the wells of the reference experiments (FIG. 5, Aa and Ba), in which only an approximately 2-5% decrease of the concentration of p-nitrophenolphosphate was observed, the wells that contained all system components (activated copolymeric surface, linker, hydrolytic enzyme and substrate) displayed an 88-92% decrease of the peak area, which indicates a completely quantitative hydrolysis of the substrate on the copolymeric chip.

1. A structured polymeric support for use in spectrometry, characterized in that it is a copolymeric support.

2. The structured copolymeric support according to claim 1, characterized in that it is a support for use in mass spectrometry.

3. The support according to claim 2, characterized in that it is a support for use in MALDI- or SELDI mass spectrometry.

4. The support according to claim 1, characterized in that the support is planar and that the structure has a depth in a range of 1 to 1000 μm.

5. The support according to claim 1, characterized in that the copolymer is composed of at least two different monomers or macromonomers derived therefrom that contain at least one vinyl group.

6. The support according to claim 5, characterized in that at least one of the monomers is substituted by at least one sulfo-, hydroxy-, carboxy- or amino group.

7. The support according to claim 5, characterized in that the monomers are selected from the group of (meth)acrylic acid, (meth)acrylates, substituted (meth)acrylates, (meth)acrylamides, substituted (meth)acrylamides, (meth)acrylonitrile, substituted (meth)acrylonitrile, styrene and substituted styrenes, divinylbenzene and substituted divinylbenzene, butadiene, ethylene glycoldimethacrylate, di(ethylene glycol)dimethacrylate, ethylene glycoldiacrylate, di(ethylene glycol)diacrylate, 3-(acryloyloxy)-2-hydroxypropylmethacrylate and N,N′-methylene bismethacrylamide.

8. The support according to claim 7, characterized in that the (meth)acrylates are alkyl(meth)acrylates, substituted alkyl(meth)acrylates, aryl(meth)acrylates or substituted aryl(meth)acrylates.

9. The support according to claim 8, characterized in that the substituted alkyl(meth)acrylates or substituted aryl(meth)acrylates have sulfo-, hydroxy-, carboxy- or amino functionalities.

10. The support according to claim 9, characterized in that the copolymer is composed of methylmethacrylate and at least one other monomer that is more hydrophobic than methylmethacrylate.

11. The support according to claim 10, characterized in that the other monomer is selected from C₂-C₁₈-alkylmethacrylate.

12. The support according to claim 11, characterized in that the monomer is butylmethacrylate.

13. The support according to claim 5, characterized in that the copolymer is composed of methylmethacrylate and at least one substituted alkylmethacrylate comprising a sulfo-, hydroxy- or carboxy functionality.

14. The support according to claim 5, characterized in that the copolymer is composed of methylmethacrylate and at least one substituted alkylmethacrylate comprising an amino functionality.

15. A process for producing structured copolymeric supports according to claim 1, characterized in that a polymerization solution comprising at least two different monomers or macromonomers to be polymerized is caused to polymerize in a mould comprising a negative of the desired structure and that the polymerizates formed are detached from the mould.

16. Use of the structured copolymeric support according to claim 1 in a mass spectrometric assay for the detection of biomolecules and metabolites, including proteins, peptides, nucleic acids and lower-molecular substances.

17. The use of the structured copolymeric support according claim 1 in other spectrometric methods than mass spectrometry.

18. The use according to claim 17 in emission or absorption spectroscopy.

19. The use of the structured copolymeric support according to claim 1 in a spectrometric method in which mass spectrometry and other spectrometric methods are combined.

20. The use according to claim 19, in which MALDI mass spectrometry and emission and/or absorption spectroscopy are combined.

21. The use according to claim 20, in which MALDI mass spectrometry and fluorescence spectroscopy are combined.
